(19) United States
(12) Patent Application Publication
(10) Pub. No.: US 2026/0234368 A1
(43) Pub. Date: Aug. 13, 2026

(54) HYDROXYPHENYLTRIAZINE CO-STABILIZERS FOR STABILIZED POLYESTERS

(71) Applicant: BASF SE, Ludwigshafen am Rhein (DE)

(72) Inventors: Tania WEYLAND, Kaisten (CH); Daniel MUELLER, Kaisten (CH); Wiebke WUNDERLICH-WIPPERT, Kaisten (CH); Michéle GERSTER, Basel (CH); Bee Suan CHUA, Singapore (SG)

(21) Appl. No.: 19/148,207

(22) PCT Filed: Jan. 12, 2024
(86) PCT No.: PCT/EP2024/050665

§ 371 Date: Jul. 15, 2025

(30) Foreign Application Priority Data
Jan. 16, 2023 (EP) 23151678.2

(51) Int. Cl. C08K 5/3492; C08J 5/18; C08K 5/20; C08K 5/315; C08K 5/3475; C08K 5/357

(52) U.S. Cl. CPC C08K 5/34922; C08J 5/18; C08K 5/20; C08K 5/315; C08K 5/3475; C08K 5/357

(57) ABSTRACT

The present invention relates to a composition comprising a polyester material, at least one compound of formula (A) as defined below, and at least one UV absorber as defined below; and to a use of the composition comprising the at least one compound of formula (A) and the at least one UV absorber for enhancing stability of a polyester material exposed to light.

The present invention relates to a composition comprising a polyester material, at least one compound of formula (A) as defined below, and at least one UV absorber as defined below; and to a use of the composition comprising the at least one compound of formula (A) and the at least one UV absorber for enhancing stability of a polyester material exposed to light. Combinations of preferred embodiments with other preferred embodiments are within the scope of the present invention.

Various light stabilizers for polyester are known and several are commercially available, such as UV absorbers. There is an ongoing need to further improve the stabilization of polyester which are already stabilized with UV absorbers.

The object was achieved by a composition comprising a polyester material,
a) at least one compound of formula (A)

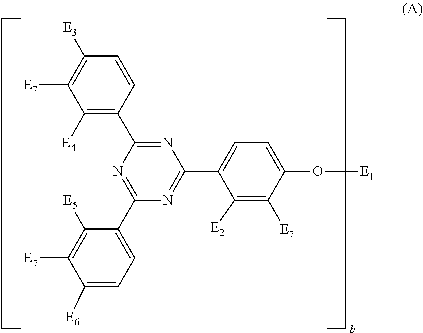

wherein
E₁ is hydrogen; C₁-C₁₈ alkyl; C₁-C₁₈ alkyl substituted by 1, 2 or 3 radicals selected from the group consisting of —OH, C₂-C₁₈ alkenyloxy, —C(O)OX₁ and —OC(O)X₂ with X₁ and X₂ being independently C₁-C₁₈ alkyl; C₃-C₅₀ alkyl interrupted by oxygen; C₃-C₅₀ hydroxyalkyl interrupted by oxygen; or a group of formula (P)

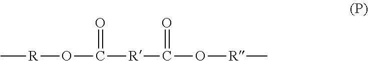

wherein, R, R′ and R″ independently of one another are C₁-C₁₈ alkylene;
b is an integer in the range of 1 to 3;
E₂ is hydrogen or hydroxyl;
E₃, E₄, E₅, and E₆ independently of one another are hydrogen; hydroxyl; C₁-C₁₈ alkyl; substituted or unsubstituted C₁-C₁₈ alkoxy; phenyl; phenyl substituted by 1, 2 or 3 C₁-C₄ alkyl; or a group of formula (Q)

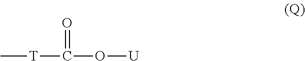

wherein T and U independently of one another are linear or branched C₁-C₁₈ alkyl;
E₇ independently of one another are hydrogen or C₁-C₈ alkyl; and
b) at least one UV absorber.

The object was also achieved by a use of the composition comprising the at least one compound of formula (A) and the at least one UV absorber for enhancing stability of a polyester material exposed to light.

The object was also achieved by a method for preparing the composition comprising contacting the polyester material, the at least one compound of formula (A) and the at least one UV absorber.

In an embodiment, E₁ is hydrogen, C₁-C₈ alkyl, C₁-C₁₈ alkyl substituted by 1 or 2 radicals selected from the group consisting of —OH, —C(O)OX₁ and —OC(O)X₂ with X₁ and X₂ being independently C₁-C₁₈ alky; or a group of formula (P), wherein b is an integer in the range of 1 to 2.

In an embodiment b is 1 or 2. In an embodiment, when b is 1 then E₁ is hydrogen, C₁-C₈ alkyl, C₁-C₁₈ alkyl substituted by 1 or 2 radicals selected from the group consisting of —OH, —C(O)OX₁ and —OC(O)X₂ with X₁ and X₂ being independently C₁-C₁₈ alky; and when b is 2 then E₁ is group of formula (P).

In an embodiment, E₂ is hydrogen or hydroxyl, and E₃, E₄, E₅, and E₆ independently of one another are hydrogen, hydroxyl, C₁-C₈ alkyl, substituted or unsubstituted C₁-C₈ alkoxy, phenyl, or a group of formula (Q).

Suitable C₁-C₁₈ alkyl are linear or branched C₁-C₁₈ alkyl, such as methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl and octadecyl.

In an embodiment E₇ independently of one another are hydrogen or methyl, preferably hydrogen.

In a preferred embodiment, the at least one compound of formula (A) is selected from the formulae (A-1), (A-2), (A-3), and (A-4):

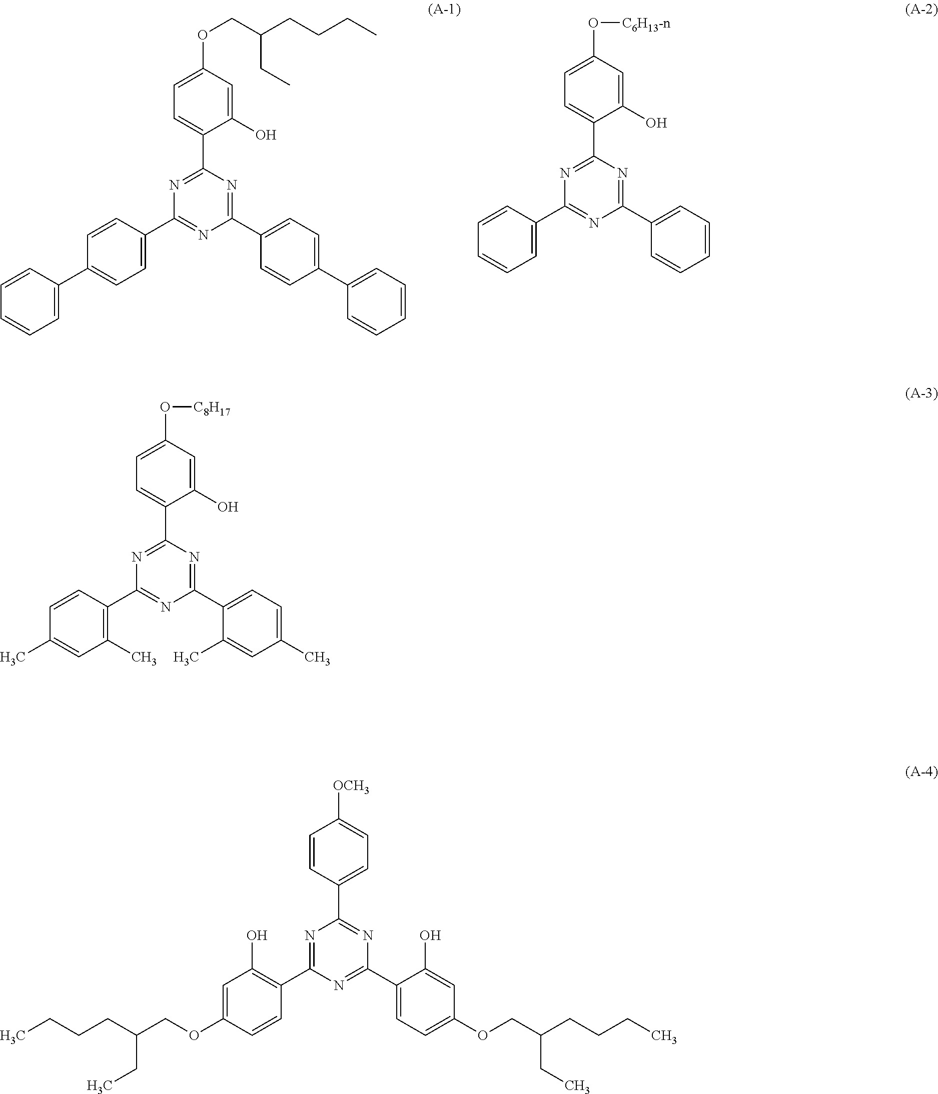

In another preferred embodiment, the at least one compound of formula (A) is selected from the formulae (A-1), (A-2) and (A-3).

In another preferred embodiment, the at least one compound of formula (A) is selected from the formulae (A-1). In another preferred embodiment, the at least one compound of formula (A) is selected from the formulae (A-2). In another preferred embodiment, the at least one compound of formula (A) is selected from the formulae (A-3). In another preferred embodiment, the at least one compound of formula (A) is selected from the formulae (A-4).

In another preferred embodiment, the at least one compound of formula (A) is selected from a mixture of the formulae (A-1) and (A-2).

Most of the compounds of the formula (A) are known and can be prepared in analogy to processes known to those skilled in the art. The compounds of the formula (A) can be prepared for example in analogy to the methods described in U.S. Pat. No. 6,255,483.

The UV absorber can be selected from the group consisting of 2-(2′-hydroxyphenyl)benzotriazoles, 2-hydroxybenzophenones, esters of substituted and unsubstituted benzoic acids, cyanoacrylates, benzoxazinones, formamidine, oxanilides, malonates, and mixtures thereof.

Preferred UV absorbers are the selected from the UV absorbers of the formulae (1) to (17)

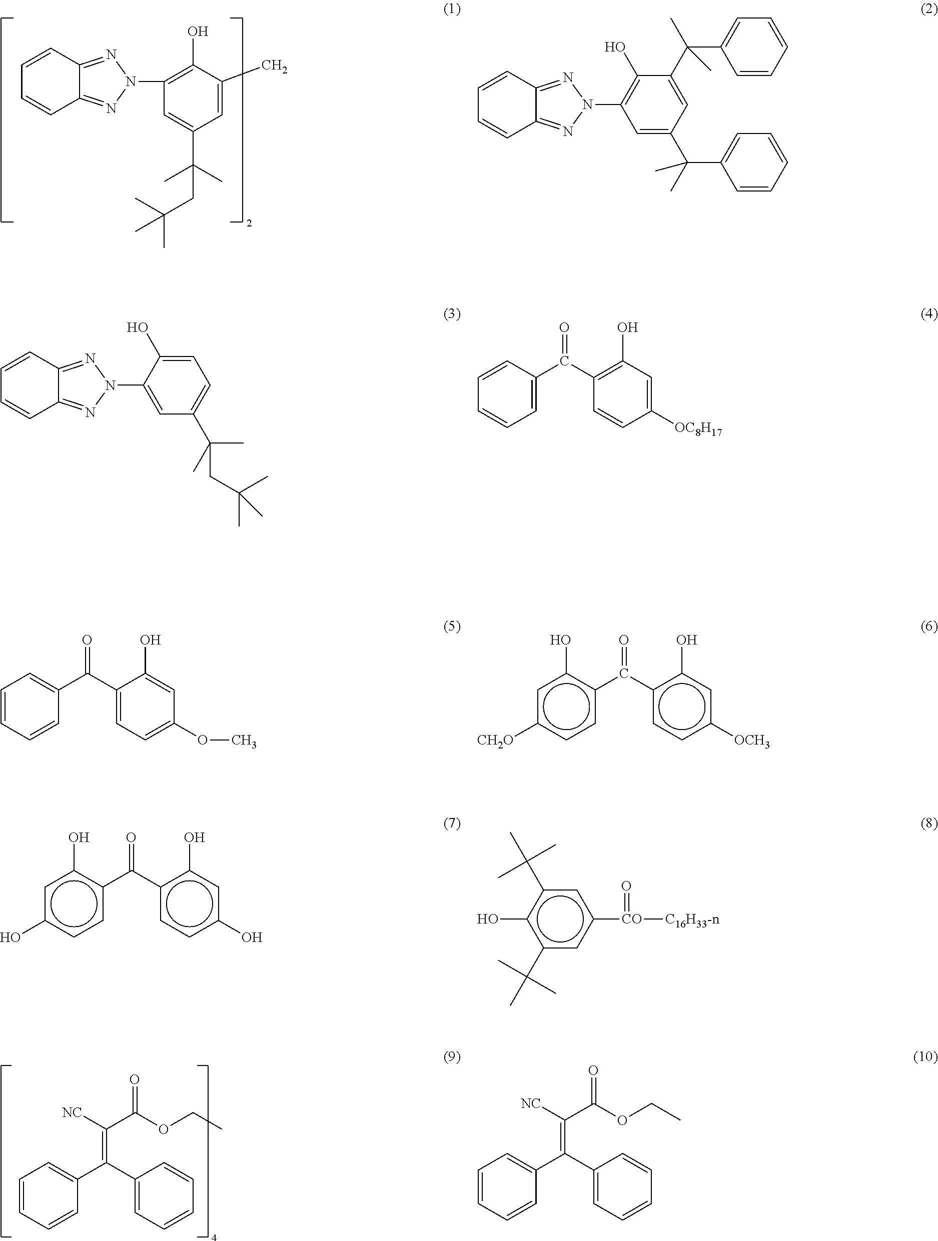

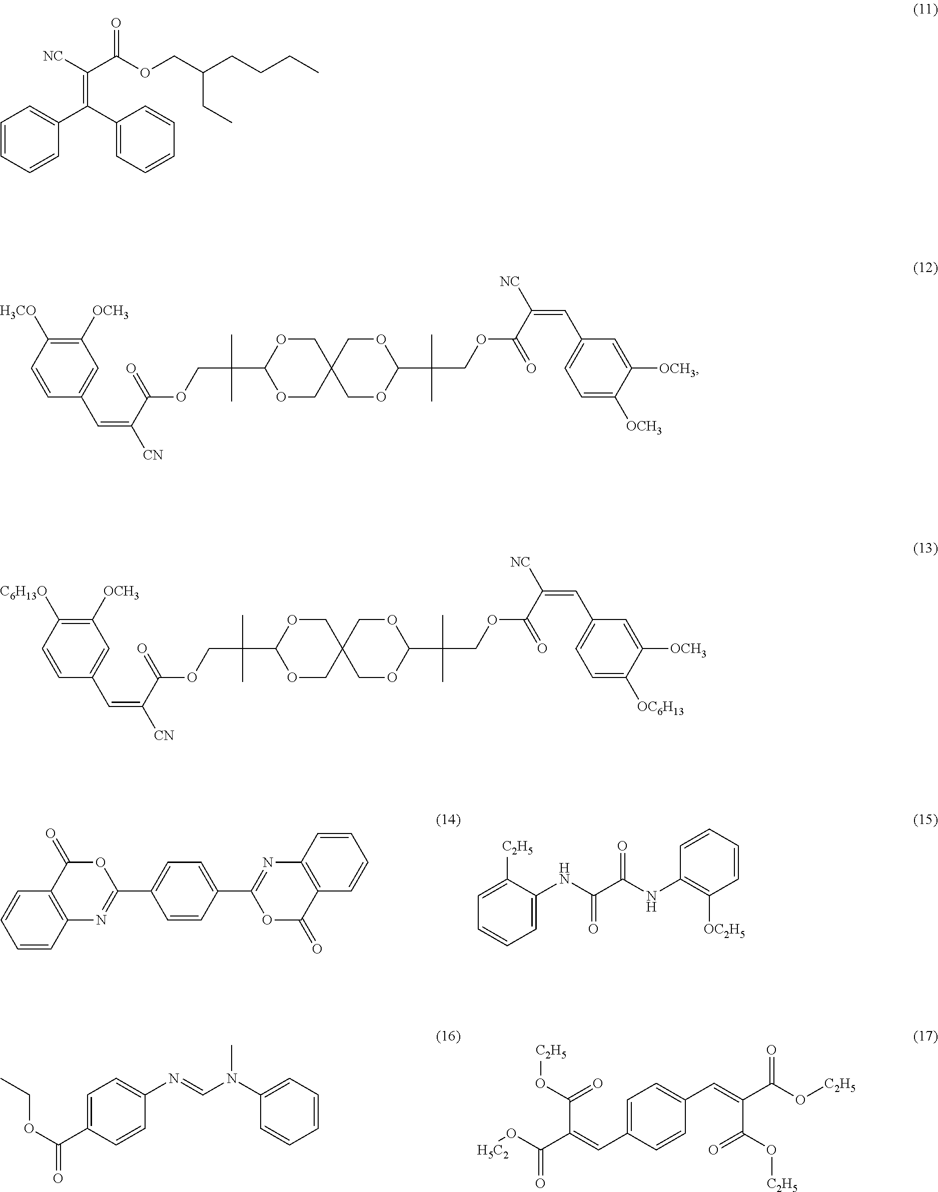

Preferred UV absorbers are the UV absorbers of the formulae (4), (8), (1), (2), (9), (14), and (15).

More preferred UV absorber are the UV absorbers of the formulae (2), (9), (14), and (15).

In a preferred form the UV absorber is of the formula (2) and the compound of formula (A) is selected from the formulae (A-1), (A-2), and (A-3).

In a preferred form the UV absorber is of the formula (2) and the compound of formula (A) is selected from the formulae (A-1), (A-2), (A-3), and (A-4).

In another preferred form the UV absorber is of the formula (2) and the compound of formula (A) is selected from the formula (A-1).

In another preferred form the UV absorber is of the formula (2) and the compound of formula (A) is selected from the formula (A-2).

In another preferred form the UV absorber is of the formula (2) and the compound of formula (A) is selected from the formula (A-3).

In another preferred form the UV absorber is of the formula (2) and the compound of formula (A) is selected from the formula (A-4).

In another preferred form the UV absorber is of the formula (9) and the compound of formula (A) is selected from the formulae (A-1), (A-2), (A-3), and (A-4).

In another preferred form the UV absorber is of the formula (9) and the compound of formula (A) is selected from the formula (A-1).

In another preferred form the UV absorber is of the formula (9) and the compound of formula (A) is selected from the formula (A-2).

In another preferred form the UV absorber is of the formula (9) and the compound of formula (A) is selected from the formula (A-3).

In another preferred form the UV absorber is of the formula (9) and the compound of formula (A) is selected from the formula (A-4).

In another preferred form the UV absorber is of the formula (9) and the compound of formula (A) is selected from a mixture of the formula (A-1) and (A-2).

In another preferred form the UV absorber is of the formula (14) and the compound of formula (A) is selected from the formulae (A-1), (A-2), (A-3), and (A-4).

In another preferred form the UV absorber is of the formula (14) and the compound of formula (A) is selected from the formula (A-1).

In another preferred form the UV absorber is of the formula (14) and the compound of formula (A) is selected from the formula (A-2).

In another preferred form the UV absorber is of the formula (14) and the compound of formula (A) is selected from the formula (A-3).

In another preferred form the UV absorber is of the formula (14) and the compound of formula (A) is selected from the formula (A-4).

In another preferred form the UV absorber is of the formula (15) and the compound of formula (A) is selected from the formulae (A-1), (A-2), (A-3), and (A-4).

In another preferred form the UV absorber is of the formula (15) and the compound of formula (A) is selected from the formula (A-1).

In another preferred form the UV absorber is of the formula (15) and the compound of formula (A) is selected from the formula (A-2).

In another preferred form the UV absorber is of the formula (15) and the compound of formula (A) is selected from the formula (A-3).

In another preferred form the UV absorber is of the formula (15) and the compound of formula (A) is selected from the formula (A-4).

In a preferred form the UV absorber is of the formula (2) and the compound of formula (A) is selected from the formulae (A-1), (A-2), and (A-3), and the polyester material is polyethylene terephthalate.

In another preferred form the UV absorber is of the formula (2) and the compound of formula (A) is selected from the formula (A-1), and the polyester material is polyethylene terephthalate.

In another preferred form the UV absorber is of the formula (2) and the compound of formula (A) is selected from the formula (A-2), and the polyester material is polyethylene terephthalate.

In another preferred form the UV absorber is of the formula (2) and the compound of formula (A) is selected from the formula (A-3), and the polyester material is polyethylene terephthalate.

In another preferred form the UV absorber is of the formula (9) and the compound of formula (A) is selected from the formulae (A-1), (A-2), (A-3), and (A-4), and the polyester material is polyethylene terephthalate.

In another preferred form the UV absorber is of the formula (9) and the compound of formula (A) is selected from the formula (A-1), and the polyester material is polyethylene terephthalate.

In another preferred form the UV absorber is of the formula (9) and the compound of formula (A) is selected from the formula (A-2), and the polyester material is polyethylene terephthalate.

In another preferred form the UV absorber is of the formula (9) and the compound of formula (A) is selected from the formula (A-3), and the polyester material is polyethylene terephthalate.

In another preferred form the UV absorber is of the formula (9) and the compound of formula (A) is selected from the formula (A-4), and the polyester material is polyethylene terephthalate.

In another preferred form the UV absorber is of the formula (9) and the compound of formula (A) is selected from a mixture of the formula (A-1) and (A-2), and the polyester material is polyethylene terephthalate.

In another preferred form the UV absorber is of the formula (14) and the compound of formula (A) is selected from the formulae (A-1), (A-2), (A-3), and (A-4), and the polyester material is polyethylene terephthalate.

In another preferred form the UV absorber is of the formula (14) and the compound of formula (A) is selected from the formula (A-1), and the polyester material is polyethylene terephthalate.

In another preferred form the UV absorber is of the formula (14) and the compound of formula (A) is selected from the formula (A-2), and the polyester material is polyethylene terephthalate.

In another preferred form the UV absorber is of the formula (14) and the compound of formula (A) is selected from the formula (A-3), and the polyester material is polyethylene terephthalate.

In another preferred form the UV absorber is of the formula (14) and the compound of formula (A) is selected from the formula (A-4), and the polyester material is polyethylene terephthalate.

In another preferred form the UV absorber is of the formula (15) and the compound of formula (A) is selected from the formulae (A-1), (A-2), (A-3), and (A-4), and the polyester material is polyethylene terephthalate.

In another preferred form the UV absorber is of the formula (15) and the compound of formula (A) is selected from the formula (A-1), and the polyester material is polyethylene terephthalate.

In another preferred form the UV absorber is of the formula (15) and the compound of formula (A) is selected from the formula (A-2), and the polyester material is polyethylene terephthalate.

In another preferred form the UV absorber is of the formula (15) and the compound of formula (A) is selected from the formula (A-3), and the polyester material is polyethylene terephthalate.

In another preferred form the UV absorber is of the formula (15) and the compound of formula (A) is selected from the formula (A-4), and the polyester material is polyethylene terephthalate.

In a preferred form the UV absorber is of the formula (2) and the compound of formula (A) is selected from the formulae (A-1), (A-2), and (A-3), and the polyester material is polyethylene terephthalate, which is present as fiber.

In another preferred form the UV absorber is of the formula (2) and the compound of formula (A) is selected from the formula (A-1), and the polyester material is polyethylene terephthalate, which is present as fiber.

In another preferred form the UV absorber is of the formula (2) and the compound of formula (A) is selected from the formula (A-2), and the polyester material is polyethylene terephthalate, which is present as fiber.

In another preferred form the UV absorber is of the formula (2) and the compound of formula (A) is selected from the formula (A-3), and the polyester material is polyethylene terephthalate, which is present as fiber.

In another preferred form the UV absorber is of the formula (9) and the compound of formula (A) is selected from the formulae (A-1), (A-2), (A-3), and (A-4), and the polyester material is polyethylene terephthalate, which is present as fiber.

In another preferred form the UV absorber is of the formula (9) and the compound of formula (A) is selected from the formula (A-1), and the polyester material is polyethylene terephthalate, which is present as fiber.

In another preferred form the UV absorber is of the formula (9) and the compound of formula (A) is selected from the formula (A-2), and the polyester material is polyethylene terephthalate, which is present as fiber.

In another preferred form the UV absorber is of the formula (9) and the compound of formula (A) is selected from the formula (A-3), and the polyester material is polyethylene terephthalate, which is present as fiber.

In another preferred form the UV absorber is of the formula (9) and the compound of formula (A) is selected from the formula (A-4), and the polyester material is polyethylene terephthalate, which is present as fiber.

In another preferred form the UV absorber is of the formula (9) and the compound of formula (A) is selected from a mixture of the formula (A-1) and (A-2), and the polyester material is polyethylene terephthalate, which is present as fiber.

In another preferred form the UV absorber is of the formula (14) and the compound of formula (A) is selected from the formulae (A-1), (A-2), (A-3), and (A-4), and the polyester material is polyethylene terephthalate, which is present as fiber.

In another preferred form the UV absorber is of the formula (14) and the compound of formula (A) is selected from the formula (A-1), and the polyester material is polyethylene terephthalate, which is present as fiber.

In another preferred form the UV absorber is of the formula (14) and the compound of formula (A) is selected from the formula (A-2), and the polyester material is polyethylene terephthalate, which is present as fiber.

In another preferred form the UV absorber is of the formula (14) and the compound of formula (A) is selected from the formula (A-3), and the polyester material is polyethylene terephthalate, which is present as fiber.

In another preferred form the UV absorber is of the formula (14) and the compound of formula (A) is selected from the formula (A-4), and the polyester material is polyethylene terephthalate, which is present as fiber.

In another preferred form the UV absorber is of the formula (15) and the compound of formula (A) is selected from the formulae (A-1), (A-2), (A-3), and (A-4), and the polyester material is polyethylene terephthalate, which is present as fiber.

In another preferred form the UV absorber is of the formula (15) and the compound of formula (A) is selected from the formula (A-1), and the polyester material is polyethylene terephthalate, which is present as fiber.

In another preferred form the UV absorber is of the formula (15) and the compound of formula (A) is selected from the formula (A-2), and the polyester material is polyethylene terephthalate, which is present as fiber.

In another preferred form the UV absorber is of the formula (15) and the compound of formula (A) is selected from the formula (A-3), and the polyester material is polyethylene terephthalate, which is present as fiber.

In another preferred form the UV absorber is of the formula (15) and the compound of formula (A) is selected from the formula (A-4), and the polyester material is polyethylene terephthalate, which is present as fiber.

The weight ratio of the at least one compound of formula (A) to the at least one UV absorber can be from 2:1 to 1:20, preferably 1.5:1 to 1:12, and in particular from 1.3:1 to 1:10.

The polyester material can be a polyester, a polyester copolymer, or a polyester blend.

The polyester may be homo- or copolyesters that are derived from aliphatic, cycloaliphatic or aromatic dicarboxylic acids and diols; or from hydroxycarboxylic acids. In addition, mixtures of the polyesters are also suitable.

The aliphatic dicarboxylic acids may contain from to 2 to 40 carbon atoms, the cycloaliphatic dicarboxylic acids from 6 to 10 carbon atoms, the aromatic dicarboxylic acids from 8 to 14 carbon atoms, the aliphatic hydrocarboxylic acids from 2 to 12 carbon atoms and the aromatic and cycloaliphatic hydroxycarboxylic acids from 7 to 14 carbon atoms.

The aliphatic diols may contain from 2 to 12 carbon atoms, the cycloaliphatic diols from 5 to 8 carbon atoms and the aromatic diols from 6 to 16 carbon atoms.

Aromatic diols will be understood as meaning those in which two hydroxyl groups are bonded to one or to different aromatic hydrocarbon radicals.

The polyesters may also be branched with minor amounts, typically 0.1 to 3 mol %, based on the dicarboxylic acids, of more than difunctional monomers (e.g. pentaerythritol, trimellitic acid, 1,3,5-tris(hydroxyphenyl)benzene, 2,4-dihydroxybenzoic acid or 2-(4-hydroxyphenyl)-2-(2,4-dihydroxyphenyl)propane).

If the polyesters are based on at least two monomers, said monomers can be randomly distributed, or they may be block polymers.

Suitable dicarboxylic acids are linear and branched saturated aliphatic dicarboxylic acids, aromatic dicarboxylic acids and cycloaliphatic dicarboxylic acids.

Suitable aliphatic dicarboxylic acids are those containing 2 to 40 carbon atoms, typically suberonic acid, oxalic acid, malonic acid, dimethylmalonic acid, succinic acid, octadecylsuccinic acid, pimelic acid, adipic acid, trimethyladipic acid, sebacic acid, azelaic acid and dimer acids (dimerisation products of unsaturated aliphatic carboxylic acids such as oleic acid), alkylated malonic and succinic acids such as octadecylsuccinic acid.

Suitable cycloaliphatic dicarboxylic acids are 1,3-cyclobutanedicarboxylic acid, 1,3-cyclopentanedicarboxylic acid, 1,3- and 1,4-cyclohexanedicarboxylic acid, 1,3- and 1,4-(dicarboxylmethyl)cyclohexane, 4,4′-dicyclohexyldicarboxylic acid.

Suitable aromatic dicarboxylic acids are preferably terephthalic acid, isophthalic acid, o-phthalic acid, as well as 1,3-, 1,4-, 2,6- or 2,7-naphthalenedicarboxylic acid, 4,4′-diphenyldicarboxylic acid, 4,4′-diphenylsulfonecarboxylic acid, 1,1,3-trimethyl-5-carboxy-3-(p-carboxyphenyl) indane, 4,4′-diphenyl ether dicarboxylic acid, bis-p-(carboxyphenyl)methane, 4,4′-benzophenonedicarboxylic acid, bis-(p-carboxyphenyl)ethane).

The aromatic dicarboxylic acids are preferred, including in particular terephthalic acid and isophthalic acid.

Further suitable dicarboxylic acids are those that contain —CO—NH— groups. Dicarboxylic acids that contain N-heterocyclic rings are also suitable, for example those that are derived from carboxyalkylated, carboxyphenylated or carboxybenzylated monoamine-s-triazinedicarboxylic acids, mono- or bishydantoins, benzimidazolenes or halogenated benzimidazolenes or parabanic acid. The carboxyalkyl groups in these compounds may contain from 3 to 20 carbon atoms.

Suitable aliphatic diols are the linear and branched aliphatic glycols, preferably those containing 2 to 12, most preferably 2 to 6, carbon atoms in the molecule, typically including: ethylene glycol, 1,2- and 1,3-propylene glycol, 1,2-, 1,3-, 2,3- or 1,4-butanediol, pentyl glycol; neopentyl glycol, 1,6-hexanediol, 1,12-dodecanediol.

A suitable cycloaliphatic diol is typically 1,4-dihydroxycyclohexane in cis- or trans-form or as cis/trans mixture. Further suitable aliphatic diols are typically 1,4-bis(hydroxymethyl)-cyclohexane (e.g. mixtures of cis and trans isomers), aromatic-aliphatic diols such as p-xylylene glycol or 2,5-dichloro-p-xylylene glycol, 2,2-(β-hydroxyethoxyphenyl)propane, as well as polyoxyalkylene glycols such as diethylene glycol, triethylene glycol or polyethylene glycol. The alkylene diols are preferably linear and preferably contain 2 to 4 carbon atoms.

Preferred diols are the alkylene diols, 1,4-dihydroxycyclohexane and 1,4-bis(hydroxymethyl)cyclohexane. Ethylene glycol and 1,4-butanediol are especially preferred.

Further suitable aliphatic diols are the β-hydroxyalkylated, preferably β-hydroxyethylated, bisphenols as exemplified by 2,2-bis-4′-(β-hydroxyethoxy)phenylpropane.

Suitable aromatic diols are mononuclear diphenols and, preferably, dinuclear diphenols which carry a hydroxyl group at each aromatic nucleus. Aromatic will be understood as meaning preferably aromatic hydrocarbon radicals such as phenylene or naphthylene.

The hydroxyl groups in the aromatic groups may be in m-position, but are preferably in p-position. The aromatic groups may be substituted by alkyl of 1 to 6 carbon atoms, halogen such as chloro or bromo and, preferably, hydrogen atoms. The aromatic groups may be connected by a direct bond or —O—, —S—, —SO₂—, —CO—, >P(O)(C₁-C₂₀ alkyl), unsubstituted or substituted alkylidene, cycloalkylidene or alkylene. Unsubstituted or substituted alkylidene is exemplified by: ethylidene, 1,1- or 2,2-propylidene, 2,2-butylidene, 1,1-isobutylidene, pentylidene, hexylidene, heptylidene, octylidene, dichloroethylidene, trichloroethylidene. Illustrative examples of unsubstituted or substituted alkylene are methylene, ethylene, phenylmethylene, diphenylmethylene, methylphenylmethylene. Illustrative examples of cycloalkylidene are cyclopentylidene, cyclohexylidene, cycloheptylidene and cyclooctylidene.

Illustrative examples of bisphenols are: bis(p-hydroxyphenyl)ether or thioether, bis(p-hydroxyphenyl)sulfone, bis(p-hydroxyphenyl)methane, bis(4-hydroxyphenyl)-2,2′-biphenyl, phenylhydroquinone, 1,2-bis(p-hydroxyphenyl)ethane, 1-phenyl-bis(p-hydroxyphenyl)methane, diphenyl bis(p-hydroxyphenyl)methane, diphenyl bis(p-hydroxyphenyl)ethane, diphenyl bis(p-hydroxyphenyl)methane, bis(3,5-dimethyl-4-hydroxyphenyl)sulfone, bis(3,5-dimethyl-4-hydroxyphenyl)-p-diisopropylbenzene, bis(3,5-dimethyl-4-hydroxyphenyl)-m-diisopropylbenzene, 2,2-bis(3′,5′-dimethyl-4′-hydroxyphenyl)propane, 1,1- or 2,2-bis(p-hydroxyphenyl)butane, 2,2-bis(p-hydroxyphenyl)hexafluoropropane, 1,1-dichloro- or 1,1,1-trichloro-2,2-bis(p-hydroxyphenyl)ethane, 1,1-bis(p-hydroxyphenyl)cyclopentane and, preferably, 2,2-bis(p-hydroxyphenyl)propane (bisphenol A) and 1,1-bis(p-hydroxyphenyl)cyclohexane (bisphenol C).

Suitable polyesters of hydroxycarboxylic acids typically include polycaprolactone, polypivalolactone or the polyesters of 4-hydroxycyclohexanecarboxylic acid or 4-hydroxybenzoic acid, 5-hydroxynaphthalene-1-carboxylic acid, 6-hydroxynaphthalene-1-carboxylic acid.

The polyesters of hydroxycarboxylic acids are obtainable from the hydroxycarboxylic acids, the corresponding cyclic monoesters (e.g. lactones, such as caprolactone), or the corresponding cyclic diesters (such as lactide). For example, polycaprolactone is obtainable by ring-opening polymerization of caprolactone; or polylactic acid is obtainable by ring-opening polymerization of lactide (also known as 3,6-dimethyl-1,4-dioxan-2,5-dion).

Preferred polyester material is polyethylene terephthalate (PET), polybutylene terephthalate (PBT), polylactic acid (PLA), polycyclohexylenedimethylene terephthalate (PCT), polyethylene naphthlate (PEN), polytrimethylene terephthalate (PTT), polyethylene furanoate (PEF) or corresponding copolymers or blends.

Preferred polyester material is PET, PBT and corresponding copolymers and blends, as exemplified by PBT/PC, PBT/ASA, PBT/ABS, PET/ABS, PET/PC or also PBT/PET/PC or PBT/PC/ABS, which preponderantly contain the indicated polyesters.

More preferred polyester materials are PET, PTT, PBT, PEF and copolymers thereof.

Particular polyester material is PET, and copolymers thereof.

The polyesters can be prepared by direct esterification (PTA process), by transesterification (DMT process), or by ring-opening polymerization of cyclic mono- or diesters.

The polyester can be a virgin polyester as well as polyester recyclate. A preferred form comprises the polyester recyclates originating from domestic and industrial waste or from useful material collections, from production waste or from obligatory returnables. As regards the chemical composition of the polyester recyclates, the particulars given above apply likewise. PET and PBT recyclates are in this case also preferred. Polyester recyclates consist primarily of PET hollow objects, especially PET bottle materials of different provenance and having a varying degree of damage. The PET bottle materials originating from different manufacturers comprise polyethylene terephthalate and also copolymers of different structure and composition, but with a preponderant content of PET structures. The recyclates may also contain minor amounts of other polymers, including polyolefins or PVC. These recyclates may furthermore contain standard impurities such as dye residues, paint residues, metal traces, fuel residues or inorganic salts.

The polyester material may comprise further additives, for example, antioxidants, processing stabilisers, light stabilisers different from the compounds of formula (A), fillers, reinforcing agents, pigments, metal deactivators, plasticisers, lubricants, emulsifiers, rheology additives, catalysts, flow-control agents, optical brighteners, flameproofing agents, antistatic agents and blowing agents.

Other suitable further additives are chain extenders, hydrolysis inhibitors, processing modifiers (e.g. based on lactone, hydroxylamines or amine oxides), anti-agglomerant (e.g. glycerol monostearate, Calcium stearate), Slip- and Anti-blocking agents, antistatic agents, anti-fogging agents, matting agent (e.g. TiO2), colorants (e.g. pigments, carbon black, dyes), flame retardants, antimicrobial agent, surface modifier (e.g. repellency-hydrophobic agent, or hydrophilic agent).

Preferred further additives, e.g. for use in polyester fibers, are antioxidants, processing stabilisers, pigments, flameproofing agents, antistatic agents, chain extenders, hydrolysis inhibitors, processing modifiers (e.g. based on lactone, hydroxylamines or amine oxides), anti-agglomerant (e.g. glycerol monostearate, Calcium stearate), Slip- and Anti-blocking agents, antistatic agents, anti-fogging agents, matting agent (e.g. TiO2), colorants (e.g. pigments, carbon black, dyes), flame retardants, antimicrobial agent, surface modifier (e.g. repellency-hydrophobic agent, or hydrophilic agent).

The further additives may for example be selected from the following list:

1. Antioxidants
1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(a-methylcyclohexyl)-4,6-dimethylphenol, 2,6-dioctadecyl-4-methylphenol, 2,4,6-tricyclohexylphenol, 2,6-di-tert-butyl-4-methoxymethyl-phenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol, 2,4-dimethyl-6-(1′-methyl-1′-tetradecyl-methyl)-phenol and mixtures thereof.
1.2. Alkylthiomethylphenols, for example 2,4-dioctylthiomethyl-6-tert-butylphenol, 2,4-dioctylthio-methyl-6-methylphenol, 2,4-dioctylthiomethyl-6-ethylphenol, 2,6-di-dodecyl-thiomethyl-4-nonyl-phenol.
1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octadecyl-oxy-phenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.
1.4. Tocopherols, for example a-tocopherol, b-tocopherol, g-tocopherol, d-tocopherol and mixtures thereof (vitamin E), vitamin E acetate. Especially preferred is the addition of 2,5,7,8-tetramethyl-2-[4,8,12-trimethyltridecyl]-chroman-6-ol], which is a commercially available vitamin E (e.g. Irganox E 201™).
1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.
1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(a-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(a-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl] terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl) pentane.
1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.
1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.
1.9. Aromatic hydroxybenzyl compounds, for example 1,3,5-tris(3,5-di-tert-butyl-4-hydroxy-benzyl)-2,4,6-trimethylbenzene, 1,4-bis(3,5-di-tert-butyl-4-hydroxybenzyl)-2,3,5,6-tetra-methylbenzene, 2,4,6-tris(3,5-di-tert-butyl-4-hydroxybenzyl)phenol.
1.10. Triazine compounds, for example 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexa-hydro-1,3,5-triazine, 1,3,5-tris(3,5-dicyclohexyl-4-hydroxybenzyl)isocyanurate.
1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid, (3,5-ditert-butyl-4-hydroxy-phenyl)methylphosphonic acid.
1.12. Acylaminophenols, for example 4-hydroxylauranilide, 4-hydroxystearanilide, octyl N-(3,5-di-tert-butyl-4-hydroxyphenyl)carbamate.
1.13. Esters of β-(3,5-di-tert-butyl-4-hydroxyphenyl)propionic acid with mono- or polyhydric alcohols, for example with methanol, ethanol, n-octanol, i-octanol, a mixture of linear and branched C₇-C₉-alkanol, octadecanol, a mixture of linear and branched C₁₃-C₁₅-alkanol, 1,6-hexanediol, 1,9-nonanediol, ethylene glycol, 1,2-propanediol, neopentyl glycol, thiodiethylene glycol, diethylene glycol, triethylene glycol, tetraethylene glycol, pentaerythritol, tris-(hydroxyethyl)isocyanurate, N,N′-bis-(hydroxy-ethyl)oxamide, 3-thiaundecanol, 3-thiapenta-decanol, trimethylhexanediol, trimethylolpropane, 4-hydroxymethyl-1-phospha-2,6,7-trioxabicyclo[2.2.2]octane. Preferred are esters of β-(3,5-di-tert-butyl-4-hydroxyphenyl)propionic acid, especially with octadecanol, such as the addition of Octadecyl-3-(3,5-di-tert.butyl-4-hydroxyphenyl)-propionate, which is a commercially available as e.g. Irganox 1076™.
1.14. Esters of β-(5-tert-butyl-4-hydroxy-3-methylphenyl)propionic acid with mono- or polyhydric alcohols, for example with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.
1.15. Esters of β-(3,5-dicyclohexyl-4-hydroxyphenyl)propionic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.16. Esters of 3,5-di-tert-butyl-4-hydroxyphenyl acetic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)ox-amide, 3-thiaundecanol, 3-thiapentadecanol, trimethylhexanediol, trimethylolpropane, 4-hydroxymethyl-1-phospha-2,6,7-trioxabicyclo[2.2.2]octane.
1.17. Amides of B-(3,5-di-tert-butyl-4-hydroxyphenyl)propionic acid, for example N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenyl-propionyl)hydrazide, N,N′-bis[2-(3-[3,5-di-tert-butyl-4-hydroxyphenyl]propionyloxy)ethyl]oxamide (Naugard XL-1 (RTM), supplied by SI Group).
1.18. Ascorbic acid (vitamin C)
1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclo-hexyl-p-phenylenediamine, N,N′-diphenyl-p-phenylenediamine, N,N′-bis(2-naphthyl)-p-phenyl-enediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, nonylated diphenylamine, octylated diphenylamine, for example p,p′-di-tert-octyldiphenylamine, 4-n-butylaminophenol, 4-butyrylaminophenol, 4-nonanoylaminophenol, 4-do-decanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodipheny-Imethane, N,N,N′,N′-tetramethyl-4,4′-diaminodiphenylmethane, 1,2-bis[(2-methylphenyl)amino]-ethane, 1,2-bis(phenylamino) propane, (o-tolyl) biguanide, bis[4-(1′,3′-dimethylbutyl)-phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines or a mixture of mono- and dialkylated tert-octylphenothiazines, N-allylphenothiazine, N,N,N′,N′-tetraphenyl-1,4-diaminobut-2-ene, N-[(1,1,3,3-tetramethylbutyl)phenyl]-1-napthalenamine] (commercially available as Irganox L06™).

Alternatively, or in addition, a commercially available mixture of additives may be used as well, of which especially preferred is Irganox 5057 ™, which is obtained by the reaction of diphenylamine with diisobutylene, and which comprises
(A)₅₀₅₇ diphenylamine;
(B)₅₀₅₇ 4-tert-butyldiphenylamine;
(C)₅₀₅₇ compounds of the group
   i) 4-tert-octyldiphenylamine,
   ii) 4,4′-di-tert-butyldiphenylamine,
   iii) 2,4,4′-tris-tert-butyldiphenylamine,
(D)₅₀₅₇ compounds of the group
   i) 4-tert-butyl-4′-tert-octyldiphenylamine,
   ii) o,o′, m,m′, or p,p′-di-tert-octyldiphenylamine,
   iii) 2,4-di-tert-butyl-4′-tert-octyldiphenylamine,
(E)₅₀₅₇ compounds of the group
   i) 4,4′-di-tert-octyldiphenylamine,
   ii) 2,4-di-tert-octyl-4′-tert-butyldiphenylamine, and
wherein not more than 5% by weight of component (A)₅₀₅₇, 8 to 15% by weight of component (B)₅₀₅₇, 24 to 32% by weight of component (C)₅₀₅₇, 23 to 34% by weight of component (D)₅₀₅₇ and 21 to 34% by weight of component (E)₅₀₅₇ are present.

2. Light stabilizers
2.5. Nickel compounds, for example nickel complexes of 2,2′-thiobis[4-(1,1,3,3-tetramethyl-butyl)phenol], such as the 1:1 or 1:2 complex, with or without additional ligands such as n-butyl-amine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzyl-phosphonic acid, nickel complexes of ketoximes, e.g. of 2-hydroxy-4-methylphenylundecyl-ketoxime, nickel complexes of 1-phenyl-4-lauroyl-5-hydroxypyrazole, with or without additional ligands.
2.6. Sterically hindered amines, for example bis(2,2,6,6-tetramethyl-4-piperidyl)sebacate, bis(2,2,6,6-tetramethyl-4-piperidyl) succinate, bis(1,2,2,6,6-pentamethyl-4-piperidyl) sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanedi-yl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperid-4-yl)sebacate, bis(1-octyloxy-2,2,6,6-tetramethyl-piperid-4-yl)succinate, bis-[2,2,6,6-tetramethyl-1-(undecyloxy)-piperidin-4-yl]carbonate, linear or cyclic condensates of N,N′-bis(2,2,6,6-tetramethyl-4-piperidyl)-hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropyl-amino)ethane, 8-acetyl-3-dodecyl-7,7,9,9-tetramethyl-1,3,8-triazaspiro[4.5]-decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl) pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperid-yl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanedi-amine and 2,4,6-trichloro-1,3,5-triazine as well as N,N-dibutylamine and 4-butylamino-2,2,6,6-tetramethylpiperidine (CAS Reg. No. [192268 64-7]); reaction products of N6,N6′-hexane-1,6-diylbis[N2, N4-dibutyl-N2,N4, N6-tris(2,2,6,6-tetramethylpiperidin-4-yl)-1,3,5-triazine-2,4,6-triamine], butanal and hydrogen peroxide; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)-ethene, N,N′-bis-formyl-N,N′-bis(2,2,6,6-tetramethyl-4-piperidyl) hexamethylenediamine, a diester of 4-methoxymethyl-enemalonic acid with 1,2,2,6,6-pentamethyl-4-hydroxy-piperidine, poly[methylpropyl-3-oxy-4-(2,2,6,6-tetramethyl-4-piperidyl)]siloxane, a reaction product of maleic acid anhydride-a-olefin copolymer with 2,2,6,6-tetramethyl-4-aminopiperidine or 1,2,2,6,6-pentamethyl-4-amino-piperidine, a mixture of oligomeric compounds which are the formal condensation products of N,N′-bis-(2,2,6,6-tetramethyl-1-propoxy-piperidin-4-yl)-hexane-1,6-diamine and 2,4-dichloro-6-{n-butyl-(2,2,6,6-tetramethyl-1-propoxy-piperidin-4-yl)-amino}-[1,3,5]triazine end-capped with 2-chloro-4,6-bis-(di-n-butylamino)-[1,3,5]triazine, a mixture of oligomeric compounds which are the formal condensation products of N,N′-bis-(2,2,6,6-tetramethyl-piperidin-4-yl)-hexane-1,6-di-amine and 2,4-dichloro-6-{n-butyl-(2,2,6,6-tetramethyl-piperidin-4-yl)-amino}-[1,3,5]triazine end-capped with 2-chloro-4,6-bis-(di-n-butylamino)-[1,3,5]triazine, (N2, N4-dibutyl-N2,N4-bis(1,2,2,6,6-pentamethyl-4-piperidinyl)-6-(1-pyrrolidinyl)-[1,3,5]-triazine-2,4-diamine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor 3058 (Clariant; CAS Reg. No. [106917-31-1]), 5-(2-ethylhexanoyl)-oxymethyl-3,3,5-trimethyl-2-morpholinone, the reaction product of 2,4-bis-[(1-cyclo-hexyloxy-2,2,6,6-piperidine-4-yl)butylamino]-6-chloro-s-triazine with N,N′-bis-(3-amino-propyl)ethylenediamine), 1,3,5-tris(N-cyclohexyl-N-(2,2,6,6-tetra-methyl-piperazine-3-one-4-yl)amino)-s-triazine, 1,3,5-tris(N-cyclohexyl-N-(1,2,2,6,6-pentamethylpiperazine-3-one-4-yl)-amino)-s-triazine.

3. Metal deactivators, for example N,N′-diphenyloxamide, N-salicylal-N′-salicyloyl hydrazine, N,N′-bis(salicyloyl) hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)-oxalyl dihydrazide, N,N′-bis(salicyloyl)thiopropionyl dihydrazide.

4. Phosphites and phosphonates such as Tris alkyl (C12-C15) phosphite, Triisodecyl phosphite, Triisotridecyl phosphite, Dioleyl Hydrogen phosphite, Triisooctyl Phosphite, Heptakis (dipropyleneglycol) Triphosphite, Trilauryl Trithio Phosphite, Tris (Dipropyleneglycol) Phosphite, Dimethyl hydrogen phosphite, Dibutyl hydrogen phosphite, Dilauryl hydrogen phosphite, Tri-C12-C14-phosphite or Bis(2-ethylhexyl) hydrogen phosphite. Other phosphites and phosphonates, which are for instance liquid ones such as Di-n-octyl hydrogen phosphite or Di-iso-octyl hydrogen phosphite, or for example triphenyl phosphite, tris(nonylphenyl) phosphite, Phenyldiisodecyl phosphite, Diphenylisodecyl phosphite, [Triphenyl phosphite, polymer with 1,4-cyclohexanedimethanol and polypropylene glycol, C10-16 alkyl esters (CAS Reg. No. 1821217-71-3)]. Further optional phosphites or phosphonates additives are for instance Alkyl (C12-C15) bisphenol A phosphite, Alkyl (C10) bisphenol A phosphite, Poly (dipropyleneglycol) phenyl phosphite, Tris (tridecyl) phosphite, Diphenyl phosphite, Dodecyl nonylphenol phosphite blend, Phenyl Neopentylene Glycol Phosphite, Poly 4,4′ Isopropylidenediphenol-C10 Alcohol Phosphite, Poly 4,4′ Isopropylidenediphenol-C12-15 Alcohol Phosphite, diphenylalkyl phosphites, phenyldialkyl phosphites, C₁₂-C₁₈ alkyl bis[4-(1-methyl-1-phenyl-ethyl)phenyl] phosphite, C₁₂-C₁₈ alkenyl bis[4-(1-methyl-1-phenyl-ethyl)phenyl] phosphite, bis[4-(1-methyl-1-phenyl-ethyl)phenyl] [(E)-octadec-9-enyl] phosphite, decyl bis[4-(1-methyl-1-phenyl-ethyl)phenyl] phosphite, didecyl[4-(1-methyl-1-phenyl-ethyl)phenyl] phosphite, [4-(1-methyl-1-phenyl-ethyl)phenyl] bis[(E)-octadec-9-enyl] phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, [2-tert-butyl-4-[1-[5-tert-butyl-4-di(tridecoxy)phosphanyloxy-2-methyl-phenyl]butyl]-5-methyl-phenyl] ditridecyl phosphite, tristearyl sorbitol triphosphite, a mixture of at least two different tris(mono-C₁-C₈-alkyl)phenyl phosphites such as for example mentioned in U.S. Pat. No. 7,468,410 B2 as products of examples 1 and 2, a mixture of phosphites comprising at least two different tris(amylphenyl) phosphites such as for example mentioned in U.S. Pat. No. 8,008,383 B2 as mixtures 14, 15, 16, 17, 18, 19, 20, 21, 22, 23, 24, 25 and 26, a mixture of a least four different phosphites comprising tris[4-(1,1-dimethylpropyl)phenyl] phosphite, [2,4-bis(1,1-dimethylpropyl)phenyl] bis[4-(1,1-dimethylpropyl)phenyl] phosphite, bis[2,4-bis(1,1-dimethylpropyl)phenyl] [4-(1,1-dimethylpropyl)phenyl] phosphite and tris[2,4-bis(1,1-dimethylpropyl)phenyl] phosphite, a mixture of phosphites comprising at least two different tris(butylphenyl) phosphites such as for example mentioned in U.S. Pat. No. 8,008,383 B2 as mixtures 34, 35, 36, 37, 38, 39 and 40, an oxyalkylene-bridged bis-(di-C₆-aryl) diphosphite or an oligomeric phosphite obtainable by condensation under removal of hydrogen chloride of (i) a trichlorophosphane, with (ii) a dihydroxyalkane interrupted by one or more oxygen atoms and with (iii) a mono-hydroxy-C₆-arene such as for example mentioned in U.S. Pat. No. 8,304,477 B2 as products of examples 1, 2, 3, 4, 5, 6, 7, 8, 9, 10, 11, 12, 13, 14, 15, 16 and 17, a polymeric phosphite obtainable by transesterification under removal of phenol of (i) triphenyl phosphite with (ii) a dihydroxyalkane optionally interrupted by one or more oxygen atoms and/or a bis-(hydroxyalkyl)(alkyl) amine and with (iii) a mono-hydroxyalkane optionally interrupted by one or more oxygen atoms such as for example mentioned in U.S. Pat. No. 8,563,637 B2 as products of examples 1, 2, 3, 4, 5, 6, 7, 8, 9, 10 and 11, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocine, bis(2,4-di-tert-butyl-6-methylphenyl)methylbis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocine, 1,3,7,9-tetra-tert-butyl-11-octoxy-5H-benzo[d][1,3,2]benzodioxaphosphocine, 2,2′,2″-nitrilo[triethyltris(3,3′,5,5′-tetra-tert-butyl-1,1′-biphenyl-2,2′-diyl)phosphite], phosphorous acid, triphenyl ester, polymer with α-hydro-ω-hydroxypoly[oxy(methyl-1,2-ethanediyl)], C10-16-alkyl esters (CAS Reg. No. [1227937-46-3]), 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorous acid, mixed 2,4-bis(1,1-dimethylpropyl)phenyl and 4-(1,1-dimethylpropyl)phenyl triesters (CAS Reg. No. [939402-02-5]).

The following phosphites are especially preferred:

Tris(2,4-di-tert-butylphenyl) phosphite (Irgafos®168, Ciba Specialty Chemicals Inc.), tris(no-nylphenyl) phosphite,

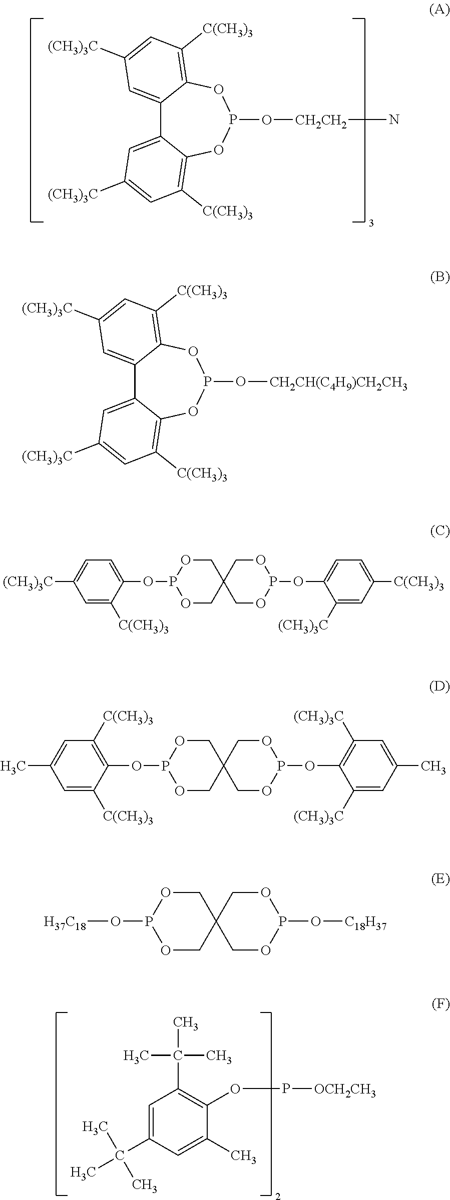

5. Hydroxylamines and amine N-oxides, for example N,N-dibenzylhydroxylamine, N,N-di-ethylhydroxylamine, N, N-dioctylhydroxylamine, N,N-dilaurylhydroxylamine, N, N-ditetradecyl-hydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine, N, N-bis-(hydrogenated rape-oil alkyl)-N-methyl-amine N-oxide or trialkylamine N-oxide.

6. Nitrones, for example N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-octadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine (optionally from vegetable source).

7. Thiosynergists, for example dilauryl thiodipropionate, dimistryl thiodipropionate, distearyl thiodipropionate and pentaerythritol tetrakis-[3-(n-lauryl)-propionic acid ester].

8. Peroxide scavengers, for example esters of a-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(b-dodecylmercapto)propionate.

10. Polyamide stabilizers, for example copper salts in combination with iodides and/or phos-phorus compounds and salts of divalent manganese.

11. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate, zeolithes, hydrotalcites, hydrocaluminates, zinc oxide.

12. Nucleating agents, for example inorganic substances, such as talcum, metal oxides, such as titanium dioxide or magnesium oxide, phosphates including phosphate salts such as 2,2′-methylene-bis(4,6-di-tert-butylphenol) phosphate sodium salt, 2,2′-methylene-bis(4,6-di-tert-butylphenol) phosphate aluminium salt or 2,2′-methylene-bis(4,6-di-tert-butylphenol) phosphate lithium salt, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate, 1,2-cyclohexane dicarboxylic acid calcium salt, bicyclo[2.2.1]heptane-2,3-dicarboxylic acid disodium salt; polymeric compounds, such as ionic copolymers (ionomers), triamino benzene derivatives such as 1,3,5-tris[2,2-dimethylpropionylamine]benzene, zinc glycerolate and nonytol derivatives. Especially preferred are 1,3:2,4-bis(3′,4′-dimethylbenzylidene)sorbitol, 1,3:2,4-di(paramethyl-dibenzylidene)sorbitol, and 1,3:2,4-di(benzylidene)sorbitol.

13. Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.

14. Other additives, for example plasticisers, lubricants, emulsifiers, pigments, rheology additives, catalysts, flow-control agents, optical brighteners, flameproofing agents, antistatic agents and blowing agents, heat stabilizers, anti-fog agents, anti-mist agents, anti-blocking additives, slip agents, anti-scratch agents.

15. Benzofuranones and indolinones, for example those disclosed in U.S. Pat. No. US-A-4,325,863; U.S. Pat. No. US-A-4,338,244; U.S. Pat. No. US-A-5,175,312; U.S. Pat. No. US-A-5,216,052; U.S. Pat. No. US-A-5,252,643; U.S. Pat. No. DE-A-4316611; U.S. Pat. No. DE-A-4316622; U.S. Pat. No. DE-A-4316876; U.S. Pat. No. EP-A-0589839 or U.S. Pat. No. EP-A-0591102, WO2015/121445, WO2017/025431, or 5,7-di-tert-butyl-3-(4-hydroxyphenyl)-3H-benzofuran-2-one, 5,7-di-tert-butyl-3-[4-(2-hydroxyethoxy)phenyl]-3H-benzofuran-2-one, 5,7-di-tert-butyl-3-[4-[2-[2-[2-[2-(2-hydroxyethoxy)ethoxy]ethoxy]ethoxy]ethoxy]phenyl]-3H-benzofuran-2-one, 3-[4-(2-acetoxy-ethoxy)phenyl]-5,7-di-tert-butylbenzofuran-2-one, 5,7-di-tert-butyl-3-[4-(2-stearoyloxy-ethoxy)phenyl]benzofuran-2-one, 3,3′-bis[5,7-di-tert-butyl-3-(4-[2-hydroxyethoxy]-phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetoxy-4-(1,1,3,3-tetramethyl-butyl)-phenyl)-5-(1,1,3,3-tetramethyl-butyl)-benzofuran-2-one, [6-[6-[6-[2-[4-(5,7-di-tert-butyl-2-oxo-3H-benzofuran-3-yl)phenoxy]ethoxy]-6-oxo-hexoxy]-6-oxo-hexoxy]-6-oxo-hexyl] 6-hydroxyhexan-oate, [4-tert-butyl-2-(5-tert-butyl-2-oxo-3H-benzofuran-3-yl)phenyl] benzoate, [4-tert-butyl-2-(5-tert-butyl-2-oxo-3H-benzofuran-3-yl)phenyl] 3,5-di-tert-butyl-4-hydroxy-benzoate and [4-tert-butyl-2-(5-tert-butyl-2-oxo-3H-benzofuran-3-yl)phenyl] 3-(3,5-di-tert-butyl-4-hydroxy-phenyl)propanoate.

16. Flame retardants
16.1. Phosphorus containing flame retardants including reactive phosphorous containing flame retardants, for example tetraphenyl resorcinol diphosphite (Fyrolflex RDP, RTM, Akzo Nobel), tetrakis(hydroxymethyl)phosphonium sulphide, triphenyl phosphate, diethyl-N,N-bis(2-hy-droxyethyl)-aminomethyl phosphonate, hydroxyalkyl esters of phosphorus acids, alkylphosphate oligomers, ammonium polyphosphate (APP), resorcinol diphosphate oligomer (RDP), phosphazene flame retardants or ethylenediamine diphosphate (EDAP).
16.2. Nitrogen containing flame retardants, for example melamine-based flame retardants, isocyanurates, polyisocyanurate, esters of isocyanuric acid, like tris-(2-hydroxyethyl)iso-cyanurate, tris(hydroxymethyl)isocyanurate, tris(3-hydroxy-n-propyl)isocyanurate, triglycidyl isocyanurate, melamine cyanurate, melamine borate, melamine phosphate, melamine pyro-phosphate, melamine polyphosphate, melamine ammonium polyphosphate, melamine am-monium pyrophosphate, dimelamine phosphate, dimelamine pyrophosphate, benzoguanamine, allantoin, glycoluril, urea cyanurate, a condensation product of melamine from the series melem, melam, melon and/or a higher condensed compound or a reaction product of melamine with phosphoric acid or a mixture thereof.
16.3. Organohalogen flame retardants, for example polybrominated diphenyl oxide, decabromodiphenyl oxide (DBDPO), tris[3-bromo-2,2-bis(bromomethyl)propyl] phosphate (PB 370, (RTM, FMC Corp.)), tris(2,3-dibromopropyl)phosphate, chloroalkyl phosphate esters such as tris(chloropropyl)phosphate, tris(2,3-dichloropropyl)phosphate, tris(1,3-dichloro-2-propyl)phosphate (Fyrol FR 2 (RTM ICL)), oligomeric chloroalkyl phosphate, chlorendic acid, tetrachlorophthalic acid, tetrabromophthalic acid, poly-b-chloroethyl triphosphonate mixture, tetrabromobisphenol A-bis(2,3-dibromopropyl ether) (PE68), brominated epoxy resin, brominated aryl esters, ethylene-bis(tetrabromophthalimide) (Saytex BT-93 (RTM, Albemarle)), bis(hexachlorocyclopentadieno) cyclooctane (Declorane Plus (RTM, Oxychem)), chlorinated paraffins, octabromodiphenyl ether, hexachlorocyclopentadiene derivatives, 1,2-bis(tribromophenoxy)ethane (FF680), tetrabromobisphenol A (Saytex RB100 (RTM, Albemarle)), ethylene bis-(dibromonorbornanedicarboximide) (Saytex BN-451 (RTM, Albemarle)), bis-(hexachlorocycloentadeno)cyclooctane, PTFE, tris(2,3-dibromopropyl) isocyanurate or ethylene-bis-tetrabromophthalimide. Some of the halogenated flame retardants mentioned above are routinely combined with an inorganic oxide synergist. Some of the halogentated flame retardants mentioned above can be used in combination with triaryl phosphates (such as the propylated, butylated triphenyl phosphates) and the like and/or with oligomeric aryl phosphates (such as resorcinol bis(diphenyl phosphate), bisphenol A bis(diphenyl phosphate), neopentylglycol bis(diphenyl phosphate)) and the like.
16.4. Inorganic flame retardants, for example aluminium trihydroxide (ATH), boehmite (AlOOH), magnesium dihydroxide (MDH), zinc borates, CaCO₃, organically modified layered silicates, organically modified layered double hydroxides, and mixtures thereof. In regard to the synergistic combination with halogenated flame retardants, the most common inorganic oxide synergists are zinc oxides, antimony oxides like Sb₂O₃ or Sb₂O₅ or boron compounds.

The contacting of the compound of the formula (A), the UV absorber and optionally the further additives in the polyester material can be achieved by conventional methods, such as adding the modifier blend or its single components to the polyester material. The components can be added to the polyester material in the form of a liquid, a powder, granule or a masterbatch. The compound of the formula (A), the UV absorber, and optionally the further additives may be added to the synthetic polymer either individually or mixed with one another.

The polyester material can be present in a wide variety of forms, for example as films, fibers (continuous or non-continuous), monofilaments, woven or nonwoven fabrics, tapes, or molded articles. Preferably, the polyester material is present as a fiber or a film. In particular, the polyester material is present as a fiber.

The fibers can be bicomponent fibers, which are meant to be fibers comprising at least two distinct polymeric domains a) and b) in intimate adherence along the length of the fibers. These can be of any shapes, and are not limited to a particular shape. Examples of such shapes are side-by-side; sheath-core, orange, and matrix and fibrils types. Preferred are sheath-core type bicomponent fibers and side-by-side type bicomponent fibers, especially sheath-core type bicomponent fibers.

The diameter of the fiber can range from 1 to 50 microns, with a preferred range of 1 to 20 microns, and a most preferred range of 1 to 10 microns. For non-round bicomponent fibers, for example, trilobal or X-shaped fibers, the diameter is measured across a circle circumscribing the outer edges of the fiber.

Suitable articles are nonwoven fabrics which shall also include webs and shall mean a textile structure of individual fibers, filaments, or threads that are directionally or randomly oriented and bonded by friction, and/or cohesion and/or adhesion and/or mechanical process, as opposed to a regular pattern of mechanically inter-engaged fibers, i.e., it is not a woven or knitted fabric. Examples of nonwoven fabrics include melt-blown filaments, spun-bond continuous filament webs, carded webs, air-laid webs, and wet-laid webs. Suitable bonding methods include thermal bonding, chemical or solvent bonding, resin bonding, mechanical needling, hydraulic needling, stitch-bonding. Suitable articles made of the polymeric material are geotextiles, roofing, cables, films, filtration media, filter, diapers, sanitary napkins, panty liners, incontinence products for adults, protective clothing, surgical drapes, surgical gown, or surgical wear.

### EXAMPLES

Unless otherwise indicated, all parts and percentages are by weight. Weight percent (wt %), if not otherwise indicated, is based on an entire composition free of any volatiles.
HPT-1: Phenol, 2-[4,6-bis([1,1′-biphenyl]-4-yl)-1,3,5-triazin-2-yl]-5-[(ethylhexyl)oxy]
HPT-2: phenol, 2-(4,6-Diphenyl-1,3,5-triazin-2-yl)-5-hexyloxy
HPT-3: 2-[4,6-Bis(2,4-dimethylphenyl)-1,3,5-triazin-2-yl]-5-(octyloxy) phenol

HPT-4: 5-[(2-ethylhexyl)oxy]-2-(4-{4-[(2-ethylhexyl)oxy]-2-hydroxyphenyl}-6-(4-methoxyphenyl)-1,3,5-triazin-2-yl)phenol
UVA-1: Phenol,2,2′-methylene-bis(6-(2H-benzotriazol-2yl)-4-(1,1,3,3tetramethylbutyl))
UVA-2:2-(2H-Benzotriazol-2-yl)-4,6-bis(1-methyl-1-phenylethyl)phenol
UVA-4: Methanone, [2-hydroxy-4-(octyloxy)phenyl] phenyl
UVA-8: 3,5-Di-t-butyl-4-hydroxybenzoic acid, n-hexadecylester
UVA-9: 1,3-bis-((2′-cyano-3′,3′-diphenylacryloyl)oxy)-2,2-bis-(((2′-cyano-3′,3′-diphenylacryloyl)oxy)methyl)-propane
UVA-14:2,2′-(1,4-Phenylene)bis[4H-3,1-benzoxazin-4-one]
UVA-15: Ethanediamide, N-(2-ethoxyphenyl)-N′-(2-ethylphenyl)

### Process for Producing PET Fibers

The additives, all in powder form or if not in powder form specifically grinded at lab-scale to obtain them in powder form, were dry blended with polyethylene terephthalate (Invista® 4048, having an intrinsic viscosity (1% solution in dichloroacetic acid) of 0.645) and <1.1% wt. of diethylene glycol, also pre-grinded into powder, in a high-speed mixer during 2 minutes at 3000 rpm to provide the formulations. Additive levels are reported in % by weight, based on the weight of the PET.

The mixtures were pre-dried at 120° C. during 8 hours in a vacuum oven. The moisture level after pre-drying, measured by Karl-Fischer titration, was <0.005%.

The dry blends were melt-extruded into pellets in a co-rotating twin-screw extruder from Collin with screw diameter of 25 mm and length to diameter ratio of 42 (table 1-3) respectively in co-rotating twin screw extruder from Berstorff with screw diameter of 25 mm and length to diameter ratio of 47 (table 4-5). The screw rotating speed was 160 rpm, the extruder temperature was set at 260° C. and the melt temperature was 270° C. The extrudate was directly cooled in water after exiting the extruder nozzle. The granulation of the extrudate took place under air. Pellets were obtained.

The pellets were pre-dried and recrystallized at 160° C. for 2 hours and in a second step at 110° C. during additional 2 hours in a vacuum oven.

The pre-dried and recrystallized pellets were then melt spun on a melt spinning machine. Fibers were spun at 290° C. under nitrogen through a Busschaert Spinboy II with a fiber diameter of 40 filaments of 4.5 dpf. The stretch ratio was 1:3.2.

### Weathering Exposure Test

The PET fibers were then rolled up on PMMA plaques to have one layer of parallel PET fibers parallel to each other. The rolled-up PET fibers were then exposed in Atlas xenon weatherometers for long-term accelerated weathering tests with parameters set in DIN EN ISO105 B04 and DIN EN ISO105 B06. The titles of each of the below Tables mention which weathering exposure was used. Measurements were made at various times, given in hours in the below Tables.

### Tensile Strength Test

The PET fibers, non-exposed and exposed, were submitted to a tensile strength test on one yarn after conditioning during 48 hours at room temperature and 55% rel. humidity. The tensile tests took place at 100 mm/min traverse speed. The retained tenacity [%] were recorded, as well as the retained elongation [%] over weathering exposure (either DIN EN ISO105 B04 or DIN EN ISO105 B06). The higher the retention over time, the better.

### Examples 1-7

All the PET fibers tested in this section (Tables 1 to 3) contained a base stabilization consisting of 0.02% of pentaerythritol tetrakis(3-(3,5-di-tert-butyl-4-hydroxyphenyl)propionate) and 0.2% of bis(2,4-dicumylphenyl) pentaerythritol diphosphite.

TABLE 1
Retained tenacity [%] over exposure according
to DIN EN ISO 105 B04.

| | | 250 h | 500 h |
|---|---|---|---|
| Comparative | 1.0% UVA-4 | 59 | 40 |
| example 1 | | | |
| Example 1 | 0.5% UVA-4 + 0.5% HPT-1 | 61 | 50 |
| Comparative | 1.0% UVA-8 | 37 | 26 |
| example 2 | | | |
| Example 2 | 0.5% UVA-8 + 0.5% HPT-1 | 67 | 46 |

The above results showed that the retained tenacity were significantly higher for the PET fibers stabilized with the inventive Examples containing a combination of one stabilizer plus a triazine-based UV absorber.

TABLE 2
Retained tenacity [%] over exposure according
to DIN EN ISO 105 B04.

| | | 500 h |
|---|---|---|
| Comparative | PET without UV absorber | 0 |
| example 3 | | |
| Comparative | 1.5% HPT-2 | 36 |
| example 4 | | |
| Example 3 | 1.125% UVA-2 + 0.375% HPT-2 | 42 |

The above results showed that the retained tenacity was significantly higher for the PET fibers stabilized with the inventive Example containing a combination of one benzotriazole-based UV-absorber plus one triazine-based UV absorber.

TABLE 3
Retained tenacity [%] over exposure according
to DIN EN ISO 105 B04.

| | | 500 h |
|---|---|---|
| Comparative | 1.5% UVA-1 | 44 |
| example 5 | | |
| Example 4 | 1.125% UVA-1 + 0.375% HPT-1 | 47 |
| Comparative | 1.5% UVA-4 | 41 |
| example 6 | | |
| Example 5 | 1.286% UVA-4 + 0.214% HPT-1 | 43 |
| Comparative | 1.5% UVA-2 | 43 |
| example 7 | | |
| Example 6 | 1.125% UVA-2 + 0.375% HPT-1 | 46 |
| Example 7 | 1.125% UVA-2] + 0.375% HPT-3 | 49 |

The above results showed that the retained tenacity were significantly higher for the PET fibers stabilized with the inventive Examples containing a combination of one benzotriazole-based UV-absorber or benzophenone-based UV-absorber plus one triazine-based UV absorber.

### Examples 8-27

All the PET fibers tested in this section (Tables 4 to 6) contained a base stabilization consisting of 0.02% of pentaerythritol tetrakis(3-(3,5-di-tert-butyl-4-hydroxyphenyl)propionate) and 0.08% of bis-(2,4-di-tert-butylphenol) pentaerythritol diphosphite.

TABLE 4
Retained elongation [%] over exposure according to DIN EN ISO 105 B06.

| | | 72 h |
|---|---|---|
| Comparative example 8 | PET without UV absorber | 17 |
| Comparative example 9 | 1.5% HPT-2 | 31 |
| Example 9 | 1.313% UVA-9 + 0.188% HPT-1 | 37 |
| Example 10 | 1.313% UVA-9 + 0.188% HPT-2 | 75 |
| Comparative example 10 | 1.0% HPT-2 | 29 |
| Example 11 | 0.75% UVA-2 + 0.25% HPT-1 | 59 |
| Comparative example 11 | 1.0% UVA-9 | 25 |
| Example 12 | 0.75% UVA-9 + 0.25% HPT-1 | 70 |
| Example 13 | 0.75% UVA-9 + 0.125% HPT-1 + 0.125% HPT-2 | 62 |
| Example 14 | 0.75% UVA-9 + 0.25% HPT-3 | 51 |
| Example 15 | 0.75% UVA-9 + 0.25% HPT-4 | 43 |
| Comparative example 12 | 1.0% UVA-14 | 19 |
| Example 16 | 0.75% UVA-14 + 0.25% HPT-2 | 24 |

The above results showed that the retained tenacity were significantly higher for the PET fibers stabilized with the inventive Examples containing a combination of one non-triazine-based UV-absorber plus one triazine-based UV absorber, or a combination of one non-triazine-based UV-absorber plus two triazine-based UV absorbers.

TABLE 5
Retained tenacity [%] over exposure according to DIN EN ISO 105 B06.

| | | 72 h |
|---|---|---|
| Comparative example 13 | PET without UV absorber | 17 |
| Comparative example 14 | 1.0% UVA-9 | 25 |
| Example 17 | 0.75% UVA-9 + 0.25% HPT-2 | 36 |
| Example 18 | 0.75% UVA-9 + 0.125% HPT-1 + 0.125% HPT-2 | 35 |
| Example 19 | 0.75% UVA-9 + 0.25% HPT-3 | 31 |
| Example 20 | 0.75% UVA-9 + 0.25% HPT-4 | 47 |
| Comparative example 15 | 1.0% UVA-14 | 28 |
| Example 21 | 0.75% UVA-14 + 0.25% HPT-2 | 46 |

The above results showed that the retained tenacity were significantly higher for the PET fibers stabilized with the inventive Examples containing a combination of one non-triazine-based UV-absorber plus one triazine-based UV absorber, or a combination of one non-triazine-based UV-absorber plus two triazine-based UV absorbers.

TABLE 6
Retained tenacity [%] over exposure according to DIN EN ISO 105 B06.

| | | 500 h |
|---|---|---|
| Comparative example 16 | 1.0% UVA-9 | 44 |
| Example 22 | 0.75% UVA-9 + 0.25% HPT-1 | 50 |
| Example 23 | 0.75% UVA-9 + 0.125% HPT-1 + 0.125% HPT-2 | 43 |
| Example 24 | 0.75% UVA-9 + 0.25% HPT-3 | 49 |
| Example 25 | 0.75% UVA-9 + 0.25% HPT-4 | 45 |
| Comparative example 17 | 1.% UVA-14 | 52 |
| Example 26 | 0.75% UVA-14 + 0.25% HPT-2 | 46 |
| Comparative example 18 | 1.0% UVA-15 | 47 |
| Example 27 | 0.75% UVA-15 + 0.25% HPT-2 | 52 |

The above results showed that the retained tenacity were significantly higher for the PET fibers stabilized with the inventive Examples containing a combination of one non-triazine-based UV-absorber plus one triazine-based UV absorber, or a combination of one non-triazine-based UV-absorber plus two triazine-based UV absorbers.

1. A composition comprising a polyester material,
a) at least one compound of formula (A) 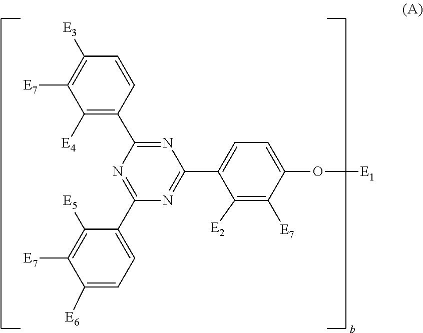
wherein
E₁ is hydrogen; C₁-C₁₈ alkyl; C₁-C₁₈ alkyl substituted by 1, 2 or 3 radicals selected from the group consisting of —OH, C₂-C₁₈ alkenyloxy, —C(O)OX₁ and —OC(O)X₂ with X₁ and X₂ being independently C₁-C₁₈ alkyl; C₃-C₅₀ alkyl interrupted by oxygen; C₃-C₅₀ hydroxyalkyl interrupted by oxygen; or a group of formula (P) 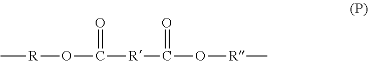
wherein, R, R′ and R″ independently of one another are C₁-C₁₈ alkylene;
b is an integer in the range of 1 to 3;
E₂ is hydrogen or hydroxyl;
E₃, E₄, E₅, and E₆ independently of one another are hydrogen; hydroxyl; C₁-C₁₈ alkyl; substituted or unsubstituted C₁-C₁₈ alkoxy; phenyl; phenyl substituted by 1, 2 or 3 C₁-C₄ alkyl; or a group of formula (Q) 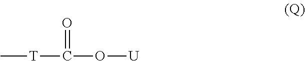
wherein T and U independently of one another are linear or branched C₁-C₁₈ alkyl;
E₇ independently of one another are hydrogen or C₁-C₈ alkyl;
and
b) at least one UV absorber.

2. The composition according to claim 1, wherein the polyester material is present as a fiber or a film.

3. The composition according to claim 1, wherein the polyester material is present as a fiber.

4. The composition according to claim 1, wherein the polyester material is a homo- or copolyesters derived from aliphatic, cycloaliphatic or aromatic dicarboxylic acids and diols; or from hydroxycarboxylic acids.

5. The composition according to claim 1, wherein the polyester material is polyethylene terephthalate (PET), polybutylene terephthalate (PBT), polylactic acid (PLA), polycyclohexylenedimethylene terephthalate (PCT), polyethylene naphthalate (PEN), polytrimethylene terephthalate (PTT), polyethylene furanoate (PEF), or corresponding copolymers or blends.

6. The composition according to claim 1, wherein the at least one compound of formula (A) is selected from formulae (A-1), (A-2), (A-3), and/or (A-4):

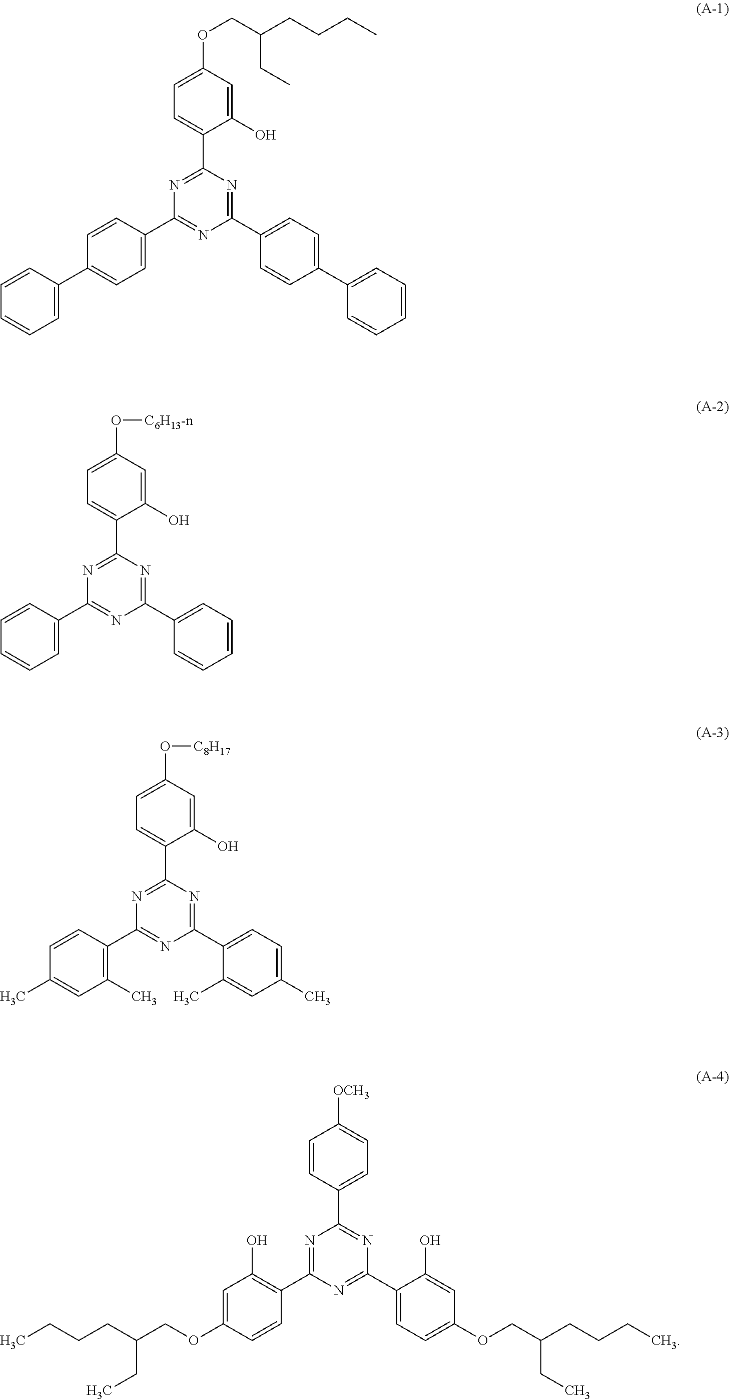

7. The composition according to claim 1, wherein the at least one UV absorber is selected from the group consisting of 2-(2′-hydroxyphenyl)benzotriazoles, 2-hydroxybenzophenones, esters of substituted and unsubstituted benzoic acids, cyanoacrylates, benzoxazinones, formamidine, oxanilides, malonates, and mixtures thereof.

8. The composition according to claim 1, wherein the at least one UV absorber is selected from UV absorbers of formulae (1) to (17):

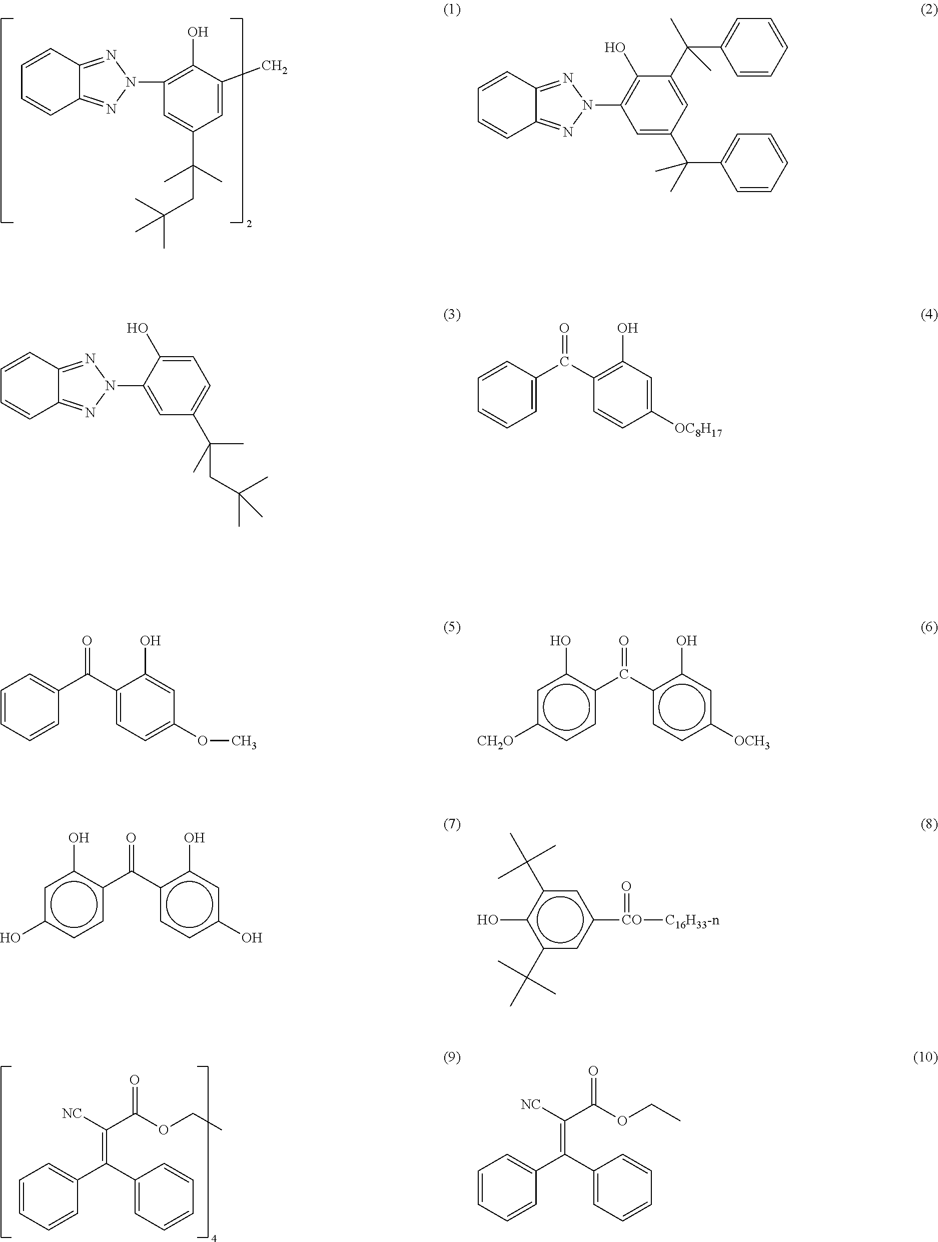

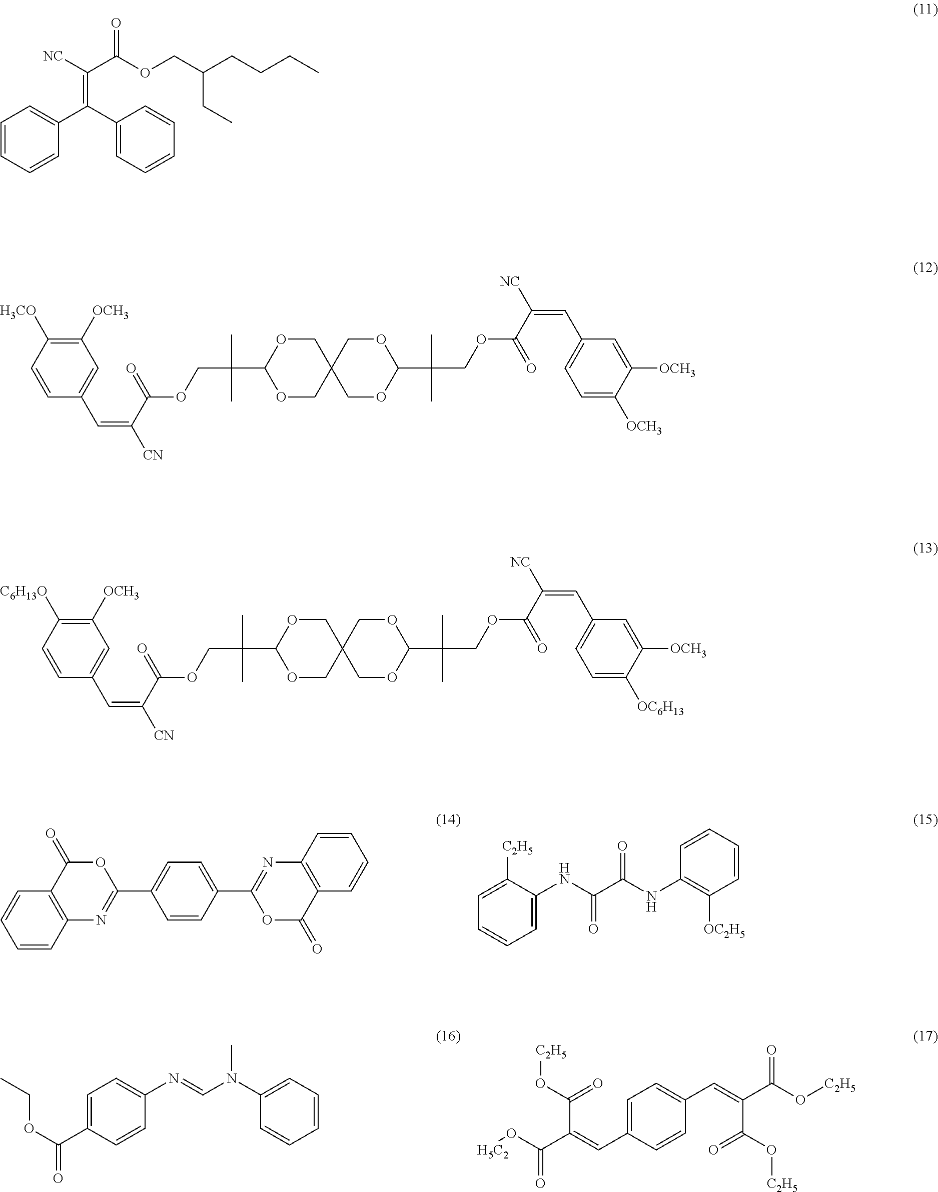

9. The composition according to claim 8, wherein the at least one UV absorber is selected from the UV absorbers of the formulae (1), (2), (4), (8), (9), (14), and/or (15).

10. The composition according to claim 8, wherein the at least one UV absorber is selected from the UV absorbers of the formulae (2), (9), (14), and/or (15).

11. The composition according to claim 1, wherein the weight ratio of the at least one compound of formula (A) to the at least one UV absorber is in the range from 2:1 to 1:20.

12. The composition according to claim 1, wherein the weight ratio of the at least one compound of formula (A) to the at least one UV absorber is in the range from 1.5:1 to 1:12.

13. The composition according to claim 1, wherein the at least one UV absorber is of the formula (2) and the at least one compound of formula (A) is selected from the formulae (A-1), (A-2), and/or (A-3).

14. The composition according to claim 1, wherein the at least one UV absorber is of the formula (9) and the compound of at least one formula (A) is selected from the formulae (A-1), (A-2), (A-3), and/or (A-4).

15. The composition according to claim 1, wherein the at least one UV absorber is of the formula (14) and the at least one compound of formula (A) is selected from the formulae (A-1), (A-2), (A-3), and/or (A-4).

16. The composition according to claim 1, wherein the at least one UV absorber is of the formula (15) and the at least one compound of formula (A) is selected from the formulae (A-1), (A-2), (A-3), and/or (A-4).

17. A method for enhancing stability of a polyester material exposed to light comprising using the at least one compound of formula (A) and the at least one UV absorber as defined in claim 1 with the polyester material.

18. A method for preparing the composition as defined in claim 1 comprising contacting the polyester material, the at least one compound of formula (A) and the at least one UV absorber.
